(19) United States
(12) Patent Application Publication
(10) Pub. No.: US 2020/0318418 A1
(43) Pub. Date: Oct. 8, 2020

(54) FENESTRATION ASSEMBLY AND INSTALLATION SYSTEM FOR THE SAME

(71) Applicant: Marvin Lumber and Cedar Company, d/b/a Marvin Windows and Doors, Warroad, MN (US)

(72) Inventors: Blake Nigel Burger, Fargo, ND (US); Eric Lee Salentine, Warroad, MN (US)

(21) Appl. No.: 16/838,496

(22) Filed: Apr. 2, 2020

Related U.S. Application Data
(60) Provisional application No. 62/828,119, filed on Apr. 2, 2019.

(51) Int. Cl. E06B 1/60

(52) U.S. Cl. CPC E06B 1/6084; E06B 1/18; E06B 1/6015

(57) ABSTRACT

A fenestration installation adjustment system includes one or more jack sockets configured to couple with a fenestration frame of a fenestration assembly. The one or more jack sockets include a contoured socket profile. One or more adjustment jacks are received in one of the one or more jack sockets. Each of the adjustment jacks includes a contoured jack profile complementary to the contoured socket profile. The adjustment jack and the contoured jack profile are movable relative to the respective jack socket along the contoured socket profile. The adjustment jacks each include an engagement foot configured for surface to surface engagement with a rough opening boundary surface. Movement of the adjustment jack relative to the jack socket is configured to move the fenestration frame according to the relative movement.

### PRIORITY APPLICATION

This application claims priority to U.S. Provisional Application Ser. No. 62/828,119, filed Apr. 2, 2019, the disclosure of which is incorporated herein in its entirety by reference.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice applies to the software and data as described below and in the drawings that form a part of this document: Copyright Marvin Lumber and Cedar Company, d/b/a Marvin Windows and Doors; Warroad Minn., USA. All Rights Reserved.

### TECHNICAL FIELD

This document pertains generally, but not by way of limitation, to fenestration assemblies and installation of the same.

### BACKGROUND

The installation of a fenestration assembly including a window, door or the like includes the positioning of the assembly within a rough opening, for instance in a wall. The frame of the fenestration assembly is installed within the rough opening. The fenestration assembly is then checked for adequate installation characteristics. For instance, the position of the fenestration assembly with respect to the rough opening is adjusted to obtain a desired reveal for the fenestration assembly (e.g., adjusting a gap between the rough opening and the fenestration assembly).

In some examples, a shim is positioned between a jamb of the fenestration frame and the rough opening. The shim is optionally moved (e.g., driven) between the jamb of the fenestration frame and rough opening to create an interference fit between the rough opening, the shim, and the jamb. Movement of the shim alters the position of the jamb with respect to the fenestration frame.

### SUMMARY

The present inventors have recognized, among other things, that a problem to be solved can include positioning a fenestration frame within a rough opening of a building with specified installation characteristics. The fenestration assembly can be installed in an existing fenestration system or a buck system. The present subject matter can help provide a solution to this problem, such as by operating a fenestration installation adjustment system. For example, the fenestration installation adjustment system includes one or more adjustment jacks, and in some examples the one or more adjustment jacks are operated to adjust the fenestration frame relative to at least one boundary surface of the rough opening.

In an example, the one or more adjustment jacks are movably coupled with one or more jack sockets. The one or more jack sockets are optionally included in the fenestration frame and the one or more jack sockets define a contoured socket profile. The one or more adjustment jacks include a contoured jack profile that is complementary to the contoured socket profile and the contoured jack profile is movably coupled along the contoured socket profile. Operation of the one or more adjustment jacks drives the contoured jack profile over the contoured socket profile, and the operation of adjustment jacks translate the fenestration frame relative to an engagement foot. The engagement foot is optionally in surface to surface engagement with the at least one boundary surface of the rough opening, and accordingly, operation of the one or more adjustment jacks adjusts the position of the fenestration frame relative to the at least one boundary surface of the rough opening.

This overview is intended to provide an overview of subject matter of the present patent application. It is not intended to provide an exclusive or exhaustive explanation of the invention. The detailed description is included to provide further information about the present patent application.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 is a perspective view of a fenestration assembly including one example of an installation adjustment system.

FIG. 2 is a detailed perspective view of a portion of the fenestration assembly of FIG. 1 including one example of an adjustment jack.

FIG. 3A is a perspective view of the adjustment jack of FIG. 2.

FIG. 3B is a sectional view of the adjustment jack of FIG. 3A.

FIG. 4A is a perspective view of one example of a jack socket including a jack insert.

FIG. 4B is a side view of the jack socket of FIG. 4A.

FIG. 5 is a detailed perspective view of a portion of the fenestration assembly of FIG. 1 including an adjustment cover.

FIG. 6A is a sectional view of another example of an installation adjustment system.

FIG. 6B is a perspective view of a supplemental example of an installation adjustment system.

FIG. 7 is a schematic view of a fenestration assembly having an installation adjustment system installed in a rough opening and including adjusted installation characteristics.

FIG. 8 is a schematic view of the fenestration assembly of FIG. 7 in an out-of-square rough opening.

FIG. 9 is a schematic view of the fenestration assembly of FIG. 7 out-of-square and in the rough opening.

FIG. 10 is a schematic view of the fenestration assembly of FIG. 7 out-of-square an in an out-of-square rough opening.

FIG. 11 is a schematic view of the fenestration assembly of FIG. 7 off-center relative to the rough opening.

FIG. 12 is a schematic view of the fenestration assembly of FIG. 7 off-level and in the rough opening.

FIG. 13 is a schematic view of the fenestration assembly of FIG. 7 with jamb-bow and in the rough opening.

FIG. 14 is a detailed perspective of the fenestration assembly of FIG. 7 including the installation adjustment system having a locking fastener.

FIG. 15 is a block diagram showing one example of adjusting installation of a fenestration assembly.

### DETAILED DESCRIPTION

In an example, a fenestration installation adjustment system includes one or more adjustment jacks, and in some examples the one or more adjustment jacks are operated to adjust a fenestration frame relative to at least one boundary surface of a rough opening.

In an example, the one or more adjustment jacks are movably coupled with one or more jack sockets. The one or more jack sockets are optionally included in the fenestration frame. For instance, a proximate portion of the fenestration frame surrounding a jack recess is the jack socket. The jack socket in this example includes, but is not limited to, the base material of the fenestration frame, such as wood, polymer, metal or a composite. In another example, the jack socket includes a jack insert coupled with the fenestration frame, for instance in the manner of a fitting including, but not limited to, snap fittings, interference fittings or the like. The jack socket, in each of the examples described herein as well as their equivalents includes a contoured socket profile. The one or more adjustment jacks include a contoured jack profile that is complementary to the contoured socket profile and the adjustment jack having the contoured jack profile is movably coupled along the contoured socket profile.

Operation of the one or more adjustment jacks drives the contoured jack profile over the contoured socket profile along with the adjustment jack. The moving adjustment jack translates the fenestration frame relative to an engagement foot (of the adjustment jacks). The engagement foot is optionally in surface to surface engagement with the at least one boundary surface of a rough opening. Accordingly, operation of the one or more adjustment jacks adjusts the position of the fenestration frame relative to the at least one boundary surface of the rough opening.

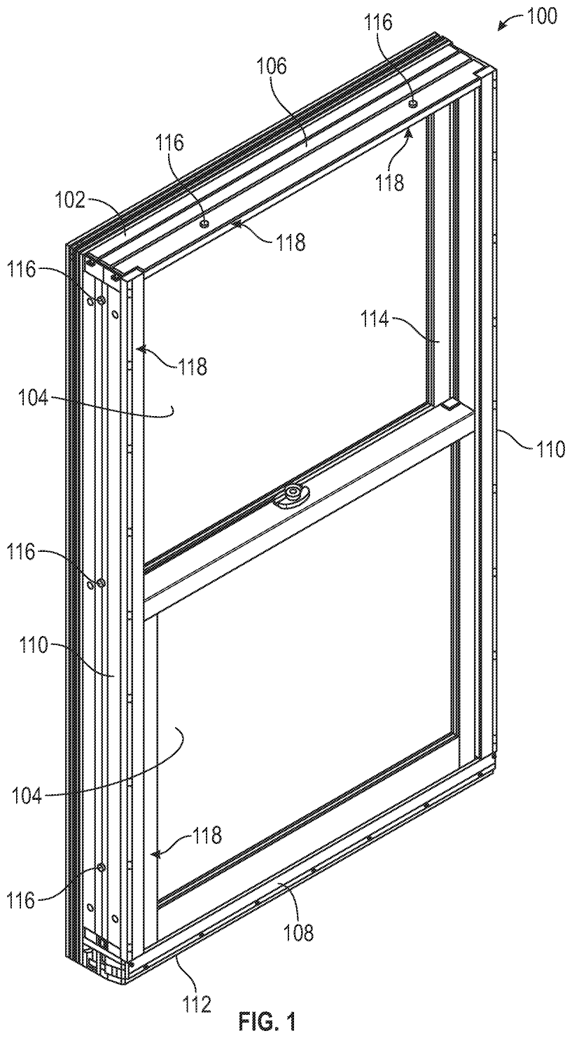

FIG. 1 is a perspective view of one example of a fenestration assembly 100 including a fenestration frame 102 and a panel 104, such as a door panel, window sash or the like coupled with the fenestration frame 102. Optionally, the panel 104 is movable relative to the fenestration frame 102, for instance through sliding of one or more panels 104 (e.g., in the manner of a single or double hung window, sliding door or the like) or rotation of the panel 104 (e.g., in the manner of a casement, awning, venting picture window or door or the like)

The fenestration frame 102 includes one or more segments, jambs or the like. In the example shown in FIG. 1, the fenestration frame 102 includes a header 106 (e.g., a header jamb), a sill 108, and jambs 110. The fenestration frame 102 includes an exterior perimeter portion 112 configured for installation within a rough opening (of a building or structure, or of a preexisting fenestration unit). The fenestration frame 102 further includes an interior perimeter portion 114. In this example, the interior perimeter portion 114 extends along the inner surface of the fenestration frame 102 while the exterior perimeter portion 112 extends along the outer surface of the frame 102.

Referring again to FIG. 1 an example installation adjustment system 118 is shown installed with the fenestration assembly 100. The installation adjustment system 118 in this example includes one or more adjustments jacks 116. As shown in FIG. 1, the example installation adjustment system 118 includes a plurality of adjustment jacks such as at least one adjustment jack 116 along each of the frame segments (e.g., one or more of the sill 108, jambs 110, or header 106). As described herein the adjustment jacks 116 are movable relative to the fenestration assembly 100, such as the fenestration frame 102. For example, the adjustment jacks 116 are coupled with the fenestration frame 102 and movement of the adjustment jacks 116, such as rotation, translates the adjustment jack 116 relative to the fenestration frame 102 through relative movement of complementary profiles. The adjustment jacks 116 include engagement features, such as engagement feet, platforms or the like engaged with portions of the rough opening, such as a boundary surface of the rough opening. Accordingly, movement of the adjustment jack 116 with the engagement feature engaged with the rough opening correspondingly moves the fenestration frame 102 and the fenestration assembly 100. As described herein, the adjustment jack 116 facilitates controlled, precise movement of the fenestration assembly 100 to address installation issues and achieve one or more installation characteristics including, but not limited to, square, level, jamb bow adjustment or the like. In other examples, the adjustment jack 116 facilitates addressing other installation issues and achieving installation characteristics, such as plumb and true (for instance, with the adjustment jack at an angle relative to vertical or an angled wedge along the rough opening that precipitates movement in or out of a wall). Additionally, the installation adjustment system 118 having one or more adjustment jacks 116 facilitates adjustment of the installation of a fenestration assembly in less than ideal circumstances including out of square rough openings, in rough openings including remainder components of prior fenestration assemblies or the like.

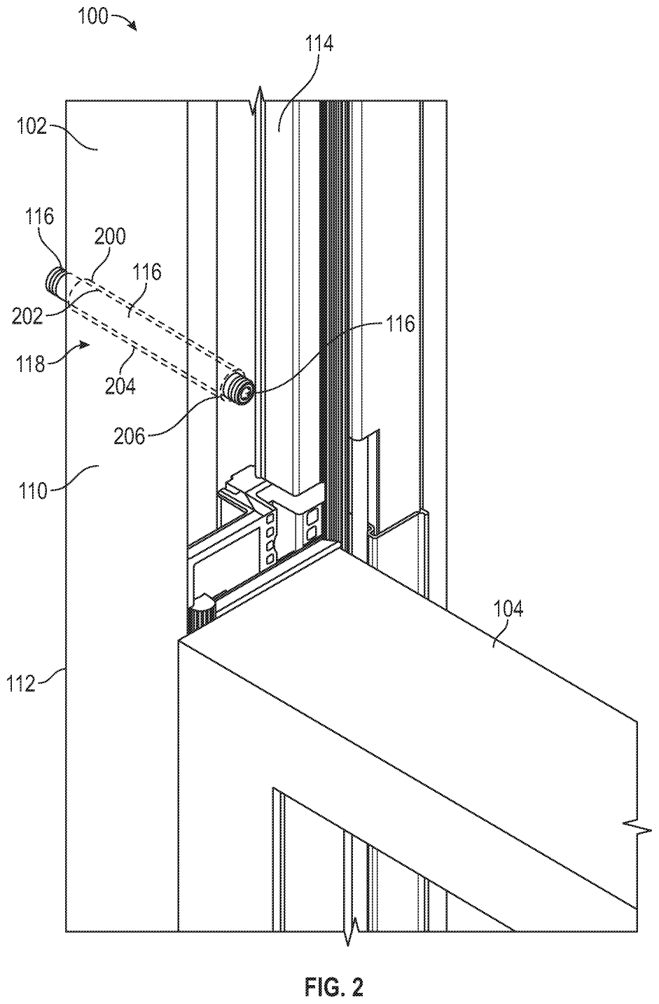

FIG. 2 is a detailed perspective view of a portion of the fenestration assembly 100. In this view a panel 104, such as a bottom sash of a window assembly, is coupled with a portion of the fenestration frame 102, the jamb 110. As shown the panel 104 is coupled along the interior perimeter portion 114 of the fenestration frame 102.

The installation adjustment system 118 in FIG. 2 includes the adjustment jack 116. In this example, the system 118 includes a single adjustment jack 116 within a jack socket 200 of the fenestration frame 102. In other examples, and as described herein, the system 118 includes two or more adjustment jacks 116 along a segment of the fenestration frame 102, such as the jambs 110, sill 108 or header 106. In still other examples, adjustment jacks 116 are coupled with the fenestration frame 102, and engagement features of the jacks 116 are coupled with a plate, such as a bar, strip or the like configured for engagement with the rough opening (e.g., a boundary surface) to distribute point loads from the adjustment jacks along the rough opening and distribute adjustments of the fenestration assembly orientation throughout the assembly 100. Examples of the installation adjustment system 118 including one or more plates are described and shown herein.

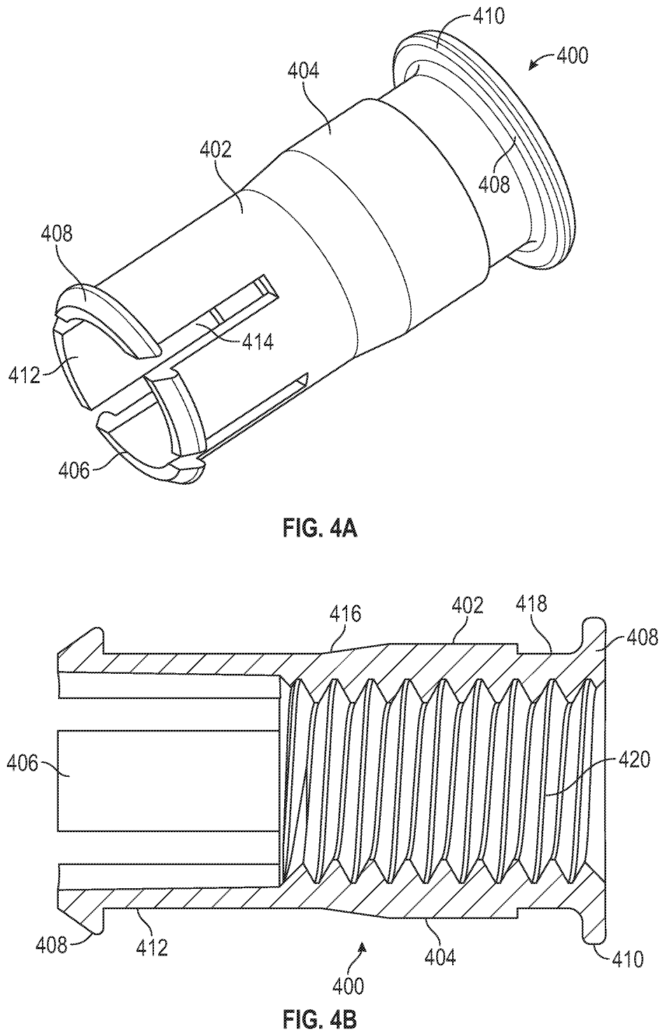

Referring again to FIG. 2, the adjustment jack 116 is received within a jack socket 200 provided in the fenestration frame 102, such as the jamb 110. As described herein the jack socket 200 includes a contoured socket profile 202 complementary to a profile of the adjustment jack 116. Accordingly, movement of the adjustment jack 116 translates the jack 116 relative to the jack socket 200 and the fenestration frame 102, thereby moving the fenestration assembly 100 within a rough opening (e.g., with an engagement feature of the jack engaged directly or indirectly with the rough opening). The jack socket 200 includes a socket integral to the fenestration frame 102, for instance formed by the material of the frame and having the contoured socket profile 202 formed in the material (e.g., threaded, self tapped by the adjustment jack or the like) and surrounding a jack recess 204 extending through the frame 102. In other examples, the jack socket 200 includes a jack insert, as shown in FIGS. 4A, B, installed within the jack recess 204. The jack insert provides the jack socket 200 having the contoured socket profile 202 complementary to the adjustment jack 200.

In the example shown in FIG. 2 the jack socket 200 extends through the fenestration frame 102, for instance from the interior perimeter portion 114 to the exterior perimeter portion 116. A jack access port 206 is provided along the frame 102, for instance along the interior perimeter portion 114 to provide access to the adjustment jack 116 and operation of the jack. As described herein, the jack access port 206 is optionally concealed with a jack cover. The jack cover includes discrete covers for each jack access port 206 and distributed covers (e.g., strips, facia or the like) coupled along the interior perimeter portion 114 to conceal multiple jack access ports 206 and provide a consistent, smooth perimeter surface.

In operation, the fenestration assembly 100 is initially installed in a rough opening of a building (e.g., a framed rough opening, remainder of a previous installed window or door or the like). One or more adjustment jacks 116 are included in the fenestration assembly 100 (or installed in the jack sockets 200 on site). The installer uses a level, or similar diagnostic tool to assess the fenestration installation, for instance to ascertain one or more installation characteristics that may benefit from adjustment. The adjustment jack 116 (or jacks 116 in assemblies having a plurality of jacks) is adjusted, for instance with a driver (manual or motor driven) engaged to the jack 116 through the jack access port 206. In one example, the complementary profiles of the jack socket 200 and the adjustment jack 116 are threaded, and rotation of the adjustment jack 116 translates the jack relative to the fenestration frame 102, for instance toward a boundary surface of the rough opening. An engagement feature of the adjustment jack 116 presses against the rough opening (directly or indirectly) and the fenestration assembly 100 is correspondingly moved in a converse manner. Alternatively, the adjustment jack 116 is moved in reverse (toward the frame) to relax pressing against the rough opening and move the fenestration assembly 100 in a converse manner.

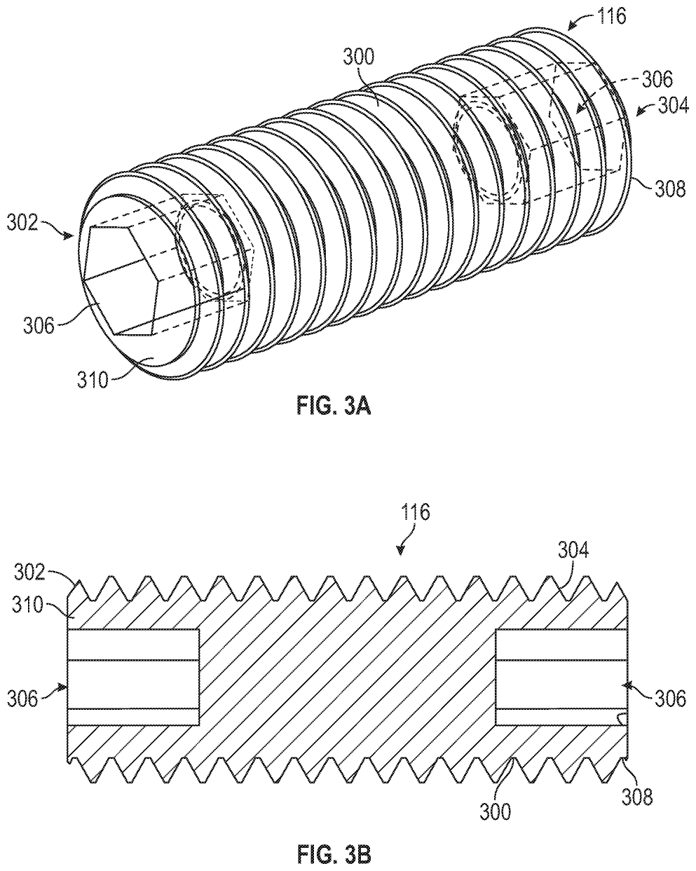

The complementary contoured profiles (e.g., the socket profile 202 and the jacket profile 300 shown in FIGS. 3A, B) include, but are not limited to, a graduated interface that translates rotational movement of the adjustment jack 116 into translation of the jack 116 relative to the jack socket 200 and the fenestration assembly 100. The graduated interface includes one or more of pitch, pitch density or the like to increase the resolution of movement of the adjustment jack 116 when operated. In one example, the complementary contoured profiles 202, 300 include threading. The pitch of the threading translates rotation of the adjustment jack 116 into translation to facilitate precise, graduated movement of the fenestration assembly 100 with operation of the installation adjustment system 118.

FIGS. 3A, B are views of one example of the adjustment jack 116. In this example, the adjustment jack 116 extends between adjustment jack ends 302, 304. The adjustment jack 116 extends the length of the jack socket 200, and in other examples extends less than the length of the jack socket 200 while access to the jack 116 is provided through the jack access port 206 (FIG. 2). One or both ends 302, 304 include engagement features, such as engagement feet 308, 310. Optionally, both ends include engagement feet 308, 310 to facilitate reversible installation of the adjustment jack 116 to the jack socket 200. The engagement feet 308, 310 are optionally planar to enhance surface to surface contact with the boundary surface of the rough opening. In other examples, the adjustment jack ends 302, 304 include grooves, recesses or the like for coupling of the engagement feet 308, 310 with a plate, such as a bar, strip or the like configured for engagement with the rough opening (e.g., a boundary surface) to distribute point loads from the adjustment jacks along the rough opening and distribute adjustments of the fenestration assembly orientation throughout the assembly 100.

As further shown in FIG. 3A, the adjustment jack 116 includes an operation feature 306 at one or both of the adjustment jack ends 302, 304. The operation feature 306 includes, but is not limited to, a slot, groove, recess, protrusion, socket or the like for interfacing with a tool, such as a driver bit (e.g., hex head, Philips head, square head or the like). Rotation is provided to the adjustment jack 116 through the operation feature 306.

Referring again to FIGS. 3A, B the adjustment jack 116 includes a contoured jack profile 300 complementary to the socket profile 202 of the jack socket 200 (e.g., as part of the fenestration frame 102 or a jack fitting installed to the frame 102). The contoured jack profile 300 includes one or more graduated features, such as grooves, threading or the like configured for movable coupling with the complementary socket profile 202. In this example, the contoured jack profile 300 extends the length of the adjustment jack 116. In another example, the contoured jack profile 300 extends between the adjustment jack ends 302, 304, for instance along the full length or a portion of the length of the jack 116.

FIGS. 4A, B are views of another example of a jack socket 400. In this example, the jack socket 400 includes a jack insert 402 configured for coupling with the fenestration assembly 100. For instance, the jack insert 402 is inserted in the jack recess 204 shown in FIG. 2. The jack insert 402 provides the jack socket 400 including a contoured socket profile 420 (shown in FIG. 4B) instead of the fenestration frame 102 having the jack socket 200 and the contoured socket profile 202 formed by the frame material (e.g., wood, metal, polymer, composite or the like) as previously described herein.

The jack insert 402 includes an insert body 404 extending between insert ends 406, 408. One or more slots 414 are optionally provided in the insert body 404 to separate deflectable fingers 412. The deflectable fingers 412 facilitate installation of the jack insert 402, for instance to the jack recess 204. The deflectable fingers 412 optionally include a flange 408. The flange 408 cooperates with deflection of the fingers 412 to facilitate installation (e.g., through the tapered profile of the flange) and anchor the insert 402 in the fenestration frame 102.

Referring now to FIG. 4B, the jack insert 402 is shown in cross section. In this example, the jack insert 402 includes a tapered portion of the insert body 404, such as an interference ridge 416. The interference ridge 416 extends between the insert ends 406, 408. In one example, the interference ridge 416 has a graduated profile larger than the jack recess 204 to provide an interference fit between the jack insert 402 and the fenestration frame 102. As the jack insert 402 is installed the interference ridge 416 snugly anchors the insert in the fenestration frame 102 through interference fitting with the fenestration assembly material surrounding the jack recess 204.

As further shown in FIG. 4B, a capture recess 418 is optionally provided between the interference ridge 416 and a flange 410 proximate the insert end 408. In this example, the flange 410 optionally engages with the fenestration frame 102, for instance the interior perimeter portion 114, to arrest further driving of the insert 402 into the frame 102. The material of the fenestration frame 102, such as wood, overlying the capture recess 418 relaxes over time into the recess 418 to further anchor the jack insert 402 in the fenestration frame 102.

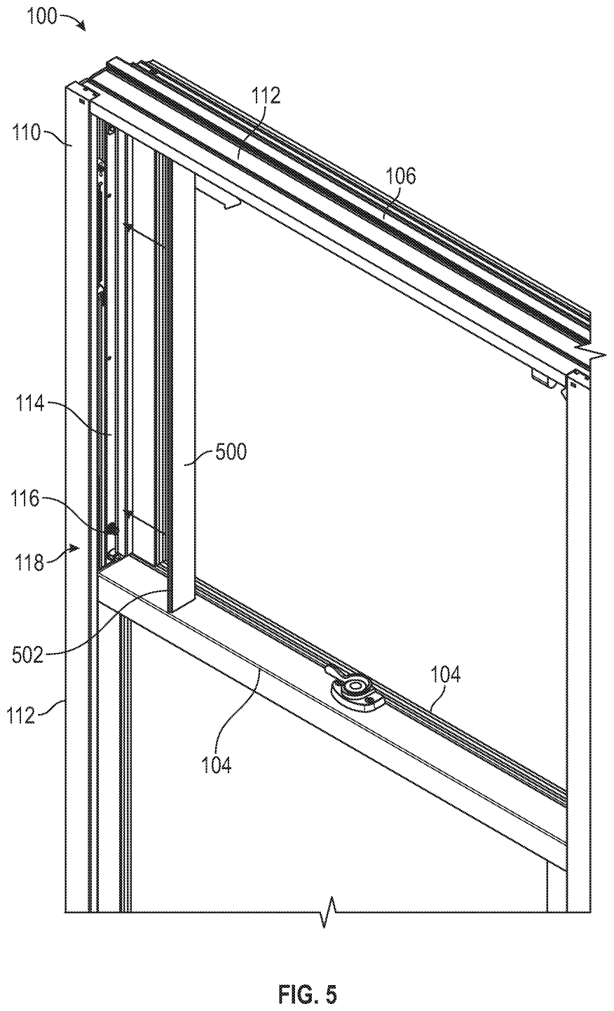

FIG. 5 is a perspective view of the fenestration assembly 100 including the installation adjustment system 118. A portion of the interior perimeter portion 114 of the fenestration frame 102 is shown with the associated adjustment jack 116 uncovered and accessible (e.g., for adjustment of one or more installation characteristics of the fenestration assembly).

An adjustment cover 500 is shown in FIG. 5. The adjustment cover 500 is decoupled from the interior perimeter portion 114 to reveal the adjustment jack 116 and allow for operation of the installation adjustment system 118. The adjustment cover includes a coupling feature such as, but not limited to, a cover flange 502 configured for reception within a corresponding groove, recess or the like proximate to the interior perimeter portion 114 of the fenestration frame 102. The cover flange 502, when coupled with the fenestration frame 102, conceals the adjustment jack 116 and provides a smooth surface along the frame 102, for instance between the front or rear portion of the fenestration assembly 100 and the proximate panel 104 (e.g., the cover is between the panel and the front or rear of the assembly). In one example, an additional cover 500 is provided for the opposed portion of the fenestration frame 102 (the right portion in contrast to the illustrate left portion).

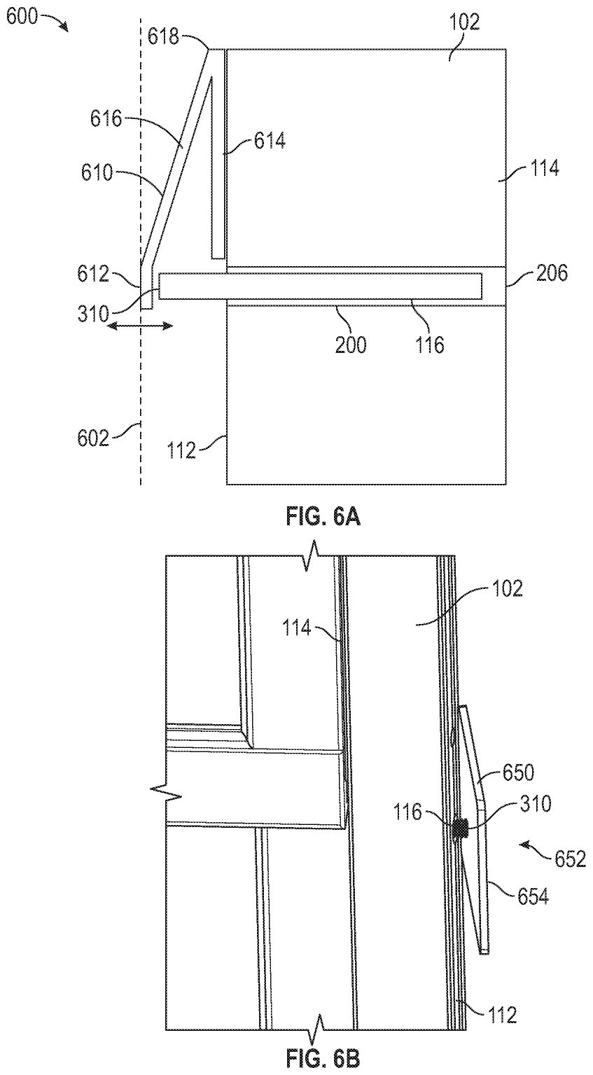

FIGS. 6A, B show additional examples of installation adjustment systems 600, 652. In these examples, the systems include adjustment plates 610, 650 that provide associated engagement feet 612, 654 configured to distribute loads otherwise transmitted from the adjustment jack 116 to the rough opening. In some examples, the adjustment plates 610, 650 enhance movement of the associated fenestration assemblies, for instance to address one or more of the installation characteristics described herein including, but not limited to, square, jamb-bow (as well as header-bow and sill-bow), level and reveal. Optionally, the distributed application of force provided with the adjustment plates enhances movement of the fenestration assembly relative to the rough opening including one or more of translation or rotation (e.g., pivoting or the like), for instance to achieve a level installation, square installation or the like.

FIG. 6A shows one example of an installation adjustment system 600, from a top-down perspective, including an adjustment jack 116 and an adjustment plate 610 associated with the jack 116. In a similar manner to previous examples the adjustment jack 116 is received in a jack socket 200 and accessed through a jack access port 206, for instance from the interior perimeter portion. The adjustment jack 116 extends from the exterior perimeter portion 112 toward the adjustment plate 610.

As further shown in FIG. 6A the adjustment plate 610 is coupled with the fenestration frame 102. For example, the plate 610 is coupled with a coupling flange 614 (e.g., fastened to the exterior perimeter portion 112). In the present example a plate arm 616 extends from a joint 618 interposed between the coupling flange 614 and the arm 616. Optionally, the adjustment plate 610 is a metal or polymer plate having a living hinge 618 as the joint 618. As described herein the adjustment plate 610 pivots relative to the coupling flange 614 with movement of the adjustment jack 116. As further shown, the adjustment plate 610 includes an engagement foot 612 configured for coupling with the rough opening 602, such as a boundary surface of the rough opening. The opposed surface of the engagement foot 612 is, in this example, coupled with the engagement foot 310 of the adjustment jack 116. The adjustment plate 610 including the engagement foot 612 extend into and out of the page, for instance along the length or a portion of the length of the fenestration frame 102. Accordingly, force transmitted from the adjustment jack 116 to the adjustment plate 610 is distributed to the rough opening 602 according the length of engagement, the area of engagement or the like between the plate 610 and the rough opening 602 in contrast to localized loading with the engagement foot 310 directly engaged with the rough opening.

In operation the adjustment jack 116 is moved, for instance with rotation, relative to the fenestration frame 102 and the jack socket 200. Movement of the adjustment jack translates the jack 116 relative to the fenestration frame 102 (e.g., in a manner corresponding to the left and right arrows shown in FIG. 6A, toward or away from the fenestration frame 102). As shown in FIG. 6A, the engagement foot 310 of the adjustment jack 116 is coupled along the adjustment plate 610, for instance at the engagement foot 612 of the plate 610. Relative translational movement of the adjustment jack 116 relative to the jack socket 200 (e.g., as pushing or relaxing of pushing) is transmitted through the engagement foot 310 and to the adjustment plate 610. The adjustment plate 610 thereby provides indirect engagement of the foot 310 to the rough opening. The adjustment plate 610 distributes pushing forces along the plate 610, for instance along the engagement foot 612, and the distributed forces are received by the rough opening 602. In a similar manner to the adjustment jack 116 and the engagement foot 310 the adjustment plate 610 presses against the rough opening and optionally does not penetrate the rough opening in the manner of a screw, nail or the like. Instead, the adjustment plate 610 (and the engagement foot 310) are engaged in surface to surface contact with the rough opening to facilitate movement of the fenestration assembly without driving the jack or plate into the rough opening material.

Outward movement of the adjustment jack 116 causes outward movement of the adjustment plate 610 and conversely moves the fenestration frame 102 (and the associated fenestration assembly 100) in an opposed direction (e.g., to the right). Inner movement of the adjustment jack 116 (e.g., toward the interior of the fenestration assembly 100) conversely relaxes the pushing force applied by adjustment plate 610 to the rough opening 602 thereby allowing the fenestration frame to move closer to the proximate surface of the rough opening 602. In some examples, and as described herein the movement of adjustment jacks 116 (and the optional adjustment plates 610) are coordinated to adjust otherwise out-of-square, off level or bowed fenestration assemblies, for instance to achieve one or more specified installation characteristics (e.g., square, level, unbowed, reveal or the like).

FIG. 6B is a perspective view of another example of an installation adjustment system 652. In this example, an adjustment plate 650 is included with the system 652 in a similar manner to the system 600 shown in FIG. 6A. Optionally, the adjustment plate 650 is coupled to the fenestration frame 102 at one end opposed to an engagement foot 654. The adjustment plate 650 pivots similar to the adjustment plate 610, for instance relative to the location the plate 650 is coupled with the frame 102.

In another example, the adjustment plate 650 includes a fitting configured for reception of the engagement foot 310. The fitting couples the engagement foot 310 with the adjustment plate 650 and permits rotation of the adjustment jack 116 relative to the plate 650.

In operation, the adjustment jack 116 is moved in a similar manner as previously described herein (e.g., to translate the jack relative to the fenestration assembly). Inward and outward movement of the jack 116 initiates corresponding movement of the adjustment plate 650, for instance corresponding inward and outward movement. Outward movement of the adjustment jack 116 presses the adjustment plate 650 and its engagement foot 654 toward the rough opening and conversely moves the proximate portion of the fenestration assembly in an opposed direction (e.g., away from the rough opening). Inward movement of the adjustment jack 116 (e.g., relaxing of the pressing engagement) toward the fenestration assembly corresponding relaxes the adjustment plate 650 and allows for its movement, also toward the fenestration assembly. The proximate portion of the fenestration frame 102 is thereby permitted to move closer to the corresponding portion of the rough opening.

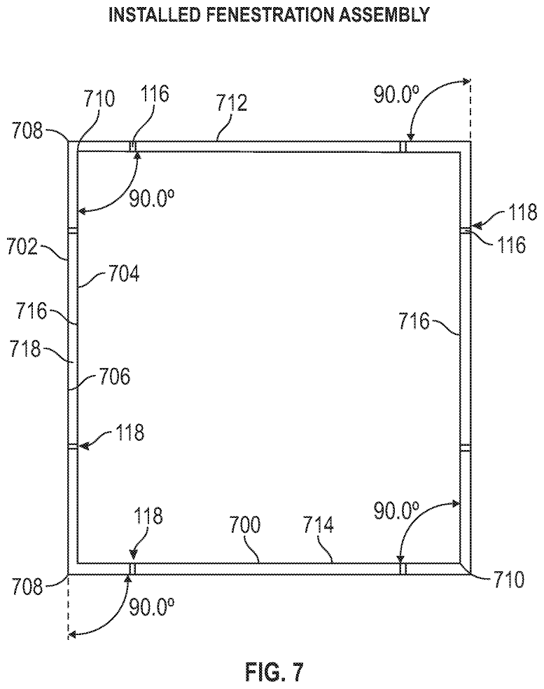

FIG. 7 is a schematic view of a fenestration assembly 700 including the installation adjustment system 118. The fenestration assembly 700 is installed in a rough opening 702 having a boundary surface 704. The rough opening 702 includes rough opening corners 708 (e.g., square or with right angles at the corners). As shown in FIG. 7, the fenestration assembly includes one or more specified installation characteristics (e.g., square, level, minimized jamb-bow, reveal or the like). The fenestration assembly 700 includes a header 712, sill 714 and jambs 716 in this example. These segments interconnect at one or more frame corners 710 having a square configuration (e.g., square or with right square angles at the corners). The fenestration assembly 700 is positioned within the rough opening 702 and includes a reveal 718, such as a spacing between segments of the fenestration frame 704 and proximate portions of the rough opening 702. FIG. 7 accordingly illustrates the fenestration assembly in an installed configuration with one or more specified installation characteristics achieved. For example, the installation adjustment system 118 is operated with the adjustment jacks 116 to adjust installation of the fenestration assembly 700 to a specified installation including one or more of specified square, level, minimized jamb-bow, reveal or the like.

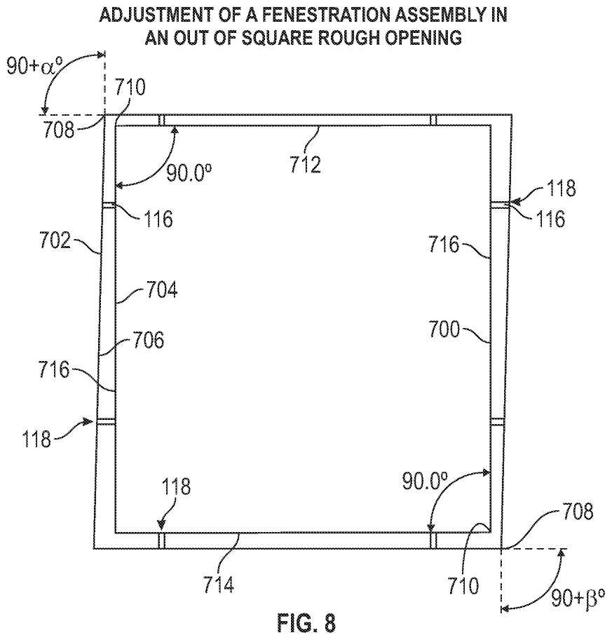

In the example shown the installation adjustment system 118 includes one or more adjustment jacks 116 along one or more segments of the fenestration frame 704. For instance, in the present example, each of the jambs 716 include one or more adjustment jacks 116 (e.g., in FIG. 7 two adjustment jacks 116 are provided along each jamb 716) extending from the fenestration assembly 700 toward the boundary surface of the 706 of the rough opening 702. As further shown in this example, one or more of the header 712 or the sill 714 include one or more adjustment jacks 116. As shown in the present example the header 712 and the sill 714 each include two adjustments jacks 116. In other examples, one or more of the frame segments, such as the jambs 716 each include one adjustment jack 116, for instance positioned proximate to a middle portion of the assembly 700 (e.g., near a check rail in an example double hung window). FIGS. 8-13 illustrate various examples of the fenestration assembly 700 with one or more installation characteristics outside of specified parameters (e.g., out-of-square, not level, with jamb-bow or the like). These installation issues are exaggerated to better explain addressing these issues and achieving specified installation characteristics with the installation adjustment system 118 described herein.

FIG. 8 shows another schematic view of the fenestration assembly 700 installed within the rough opening, in this example an out-of-square rough opening 702. For instance the out-of-square rough opening 702 includes one or more rough opening corners 708 that are out-of-square (e.g., with angle measurements of 90 degrees plus or minus one or more degrees, such as α or β). In this example, the installation adjustment system 118 including the one or more adjustment jacks 116 is operated to adjust the fenestration assembly 700 to achieve a specified installation while minimizing the effect of the out-of-square rough opening 702. For instance, as shown the adjustment jacks 116 along the jambs 716 are operated to adjust the orientation of the fenestration assembly 700 with respect to the out-of-square rough opening 702. In the example shown in FIG. 8, the lower adjustment jack 116 of the left jamb 716 is operated (e.g., through rotation or another movement) to translate the adjustment jack 116 and its engagement feature, such as the engagement foot 308 (or 310) or engagement plate 610 outwardly relative to the jamb 716. With the engagement feature of the lower adjustment jack 116 coupled with the boundary surface 706 the fenestration assembly 700 moves in a converse direction (e.g., inward and rotates counter-clockwise).

In another example including the upper adjustment jack 116, the upper jack 116 is optionally operated in a reverse manner with the adjustment jack moved inwardly toward the fenestration assembly 700 to relax the bias otherwise provided with the upper jack 116. In still another example, the adjustment jacks 116 associated with the opposed jamb 716 are operated in a similar (though opposite) manner to adjust the fenestration assembly 700 relative to the out-of-square rough opening corner 708 shown at the bottom right portion of FIG. 8.

In another example including one adjustment jack 116 along each of one or more of the frame segments, the adjustment jacks 116 are operated in concert to adjust the installation of the fenestration assembly, for instance through movement of adjustment jacks 116 along each of the jambs 716 and the sill 714. For instance, the adjustment jacks 116 along proximate frame segments, such as one of the jambs 716 and the sill 714 are each operated to adjust the orientation of the fenestration assembly 700 and achieve one or more of level or square installation characteristics.

The one or more adjustment jacks 116 of the installation adjustment system 118 are thereby operated to orient the fenestration assembly 700 within a non-ideal rough opening, such as the out-of-square rough opening 702. For instance, each of level and square installation characteristics are achieved for the fenestration assembly 700 with the one or more adjustment jacks 116.

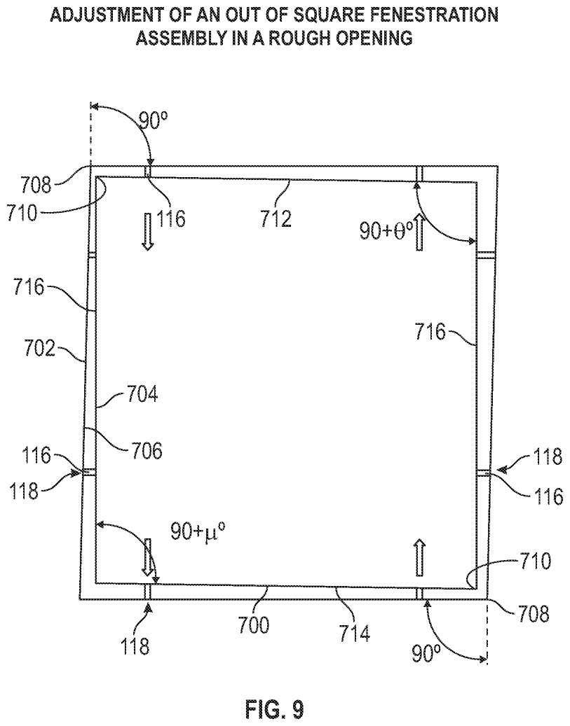

FIG. 9 shows another schematic view of the fenestration assembly, in this example an out of square fenestration assembly 700 installed within a square rough opening 702. For instance the out-of-square fenestration assembly 700 includes one or more frame corners 710 that are out-of-square (e.g., with angle measurements of 90 degrees plus or minus one or more degrees, such as μ or θ). In this example, the installation adjustment system 118 including the one or more adjustment jacks 116 is operated to adjust the fenestration assembly 700 to achieve a specified installation including addressing the out-of-square fenestration frame 704. For instance, as shown the adjustment jacks 116 along the jambs 716 are operated to adjust the orientation of the out-of-square fenestration frame 704 with respect to the rough opening 702. In the example shown in FIG. 9, the lower right adjustment jack 116 of the sill 714 is operated (e.g., through rotation or another movement) to translate the adjustment jack 116 and its engagement feature, such as the engagement foot 308 (or 310) or engagement plate 610 relative to the sill 714. With the engagement feature of the lower adjustment jack 116 coupled with the boundary surface 706 the fenestration assembly 700 moves in a converse direction (up) and adjusts the frame corner having the angle measurement 90 plus μ in FIG. 9.

In another example including the left adjustment jack 116 along the sill 714, the left jack 116 is optionally operated in a reverse manner with the adjustment jack moved inwardly toward the fenestration assembly 700 to relax the bias otherwise provided with the left jack 116. In still another example, the adjustment jacks 116 associated with the opposed header 712 are operated in a similar (though opposite) manner to adjust the fenestration assembly 700 having the frame corner with the angle measurement 90 plus θ shown at the top right portion of FIG. 9. For example, the adjustment jack 116 proximate to the corner (the upper right side of the header 712) is translated inwardly toward the fenestration assembly and the adjustment jack 116 proximate the opposed corner (the upper left side of the header 712) is translated outwardly toward the adjacent rough opening boundary surface 706. The header 712 accordingly rotates counterclockwise and decreases the angle at the upper right frame corner (e.g., from 90 plus θ toward 90 degrees).

In another example including one adjustment jack 116 along each of one or more of the frame segments, the adjustment jacks 116 are operated in concert to adjust the installation of the fenestration assembly, for instance through movement of adjustment jacks 116 along each of the sill 714, the header 712 and the jambs 710. The adjustment jacks 116 along proximate frame segments, such as the left jamb 716 and the sill 714 are each operated to adjust the orientation of the fenestration assembly 700 proximate to the frame corner having the angle measurement 90 plus μ, for instance with one or both of the jack 116 along the sill 714 translated outwardly and the jack 116 along the proximate jamb 716 translated outwardly to achieve the square installation characteristic (e.g., by decreasing the angle at the corner to 90 degrees).

The one or more adjustment jacks 116 of the installation adjustment system 118 are thereby operated to orient the out-of-square fenestration assembly 700 within the rough opening 702 and adjust the assembly 700 to have a square installation characteristic. Accordingly, the one or more adjustment jacks 116 adjust the fenestration assembly 700 to minimize (e.g., decrease or eliminate) an out-of-square configuration and instead achieve a square configuration for the assembly.

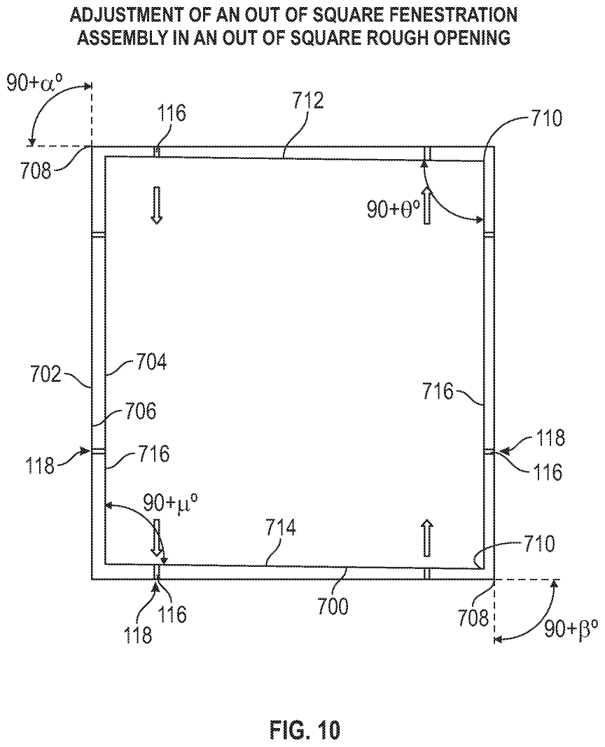

FIG. 10 shows another schematic view of the fenestration assembly 700 installed to the rough opening 702. In this example each of the fenestration assembly 700 and the rough opening 702 vary from one or more specified installation characteristics. As shown, one or more frame corners 710 and rough opening corners 708 are out-of-square. For instance the out-of-square fenestration assembly 700 includes one or more frame corners 710 that are out-of-square (e.g., with angle measurements of 90 degrees plus or minus one or more degrees, such as μ or θ) and the rough opening includes one or more rough opening corners 708 that are out of square (e.g., with angle measurements of 90 degrees plus or minus one or more degrees, such as α or β).

In this example, the installation adjustment system 118 including the one or more adjustment jacks 116 is operated to adjust the fenestration assembly 700 to achieve a specified installation including adjusting the out-of-square fenestration frame 704 relative to the out-of-square rough opening 702. For instance, as shown the adjustment jacks 116 along the jambs 716, header 712, and sill 714 are operated as discussed herein to adjust characteristics of the fenestration frame 704 while installed within the out-of-square rough opening 702.

In the example shown in FIG. 10, the lower right adjustment jack 116 of the sill 714 is operated (e.g., through rotation or another movement) to translate the adjustment jack 116 and its engagement feature, such as the engagement foot 308 (or 310) or engagement plate 610 relative to the sill 714. With the engagement feature of the lower adjustment jack 116 coupled with the boundary surface 706 the fenestration assembly 700 moves in a converse direction (up) and adjusts the frame corner having the angle measurement 90 plus μ in FIG. 9 (e.g., toward square or 90 degrees). Optionally, the lower left adjustment jack 116 along the sill 714 is conversely operated (inwardly toward the assembly 700) to facilitate downward adjustment of the sill 714 with the lower right jack. In a similar manner the adjustment jacks 116 along the header 712 are operated (e.g., in a converse manner) to address the out-of-square frame corner 710 having the angle measure 90 plus θ). The installation adjustment system 118 having the adjustment jacks 116 accordingly adjusts the fenestration assembly 700 to achieve specified installation characteristics (e.g., square in this example) through adjustment of the otherwise out-of-square assembly 700 within a rough opening 702 that is also out-of-square.

In another example including one adjustment jack 116 along each of one or more of the frame segments, the adjustment jacks 116 are operated in concert to adjust the installation of the out-of-square fenestration assembly in the out-of-square rough opening 702. The adjustment jacks 116 along proximate frame segments, such as the left jamb 716 and the sill 714 are each operated to adjust the orientation of the fenestration assembly 700 proximate to the frame corner having the angle measurement 90 plus μ, for instance with one or both of the jack 116 along the sill 714 translated outwardly and the jack 116 along the proximate jamb 716 translated outwardly to achieve the square installation characteristic (of 90 degrees). In a similar manner one or more of the adjustment jacks 116 along the header 712 and the right jamb 716 are translated outwardly to achieve a square installation characteristic (of 90 degrees).

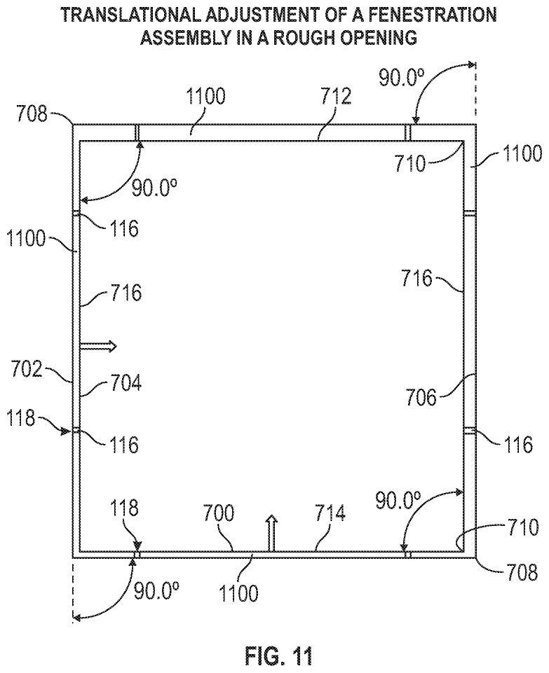

FIG. 11 shows another schematic view of the fenestration assembly 700 installed within the rough opening 702. In this example an uneven reveal 1100 installation characteristic is shown between the fenestration frame 704 and the boundary surface 706. For instance, the fenestration assembly 700 is off center relative to the rough opening 702. The installation adjustment system 118 including the one or more adjustment jacks 116 is operated to adjust the fenestration assembly 700 to achieve a specified installation including adjusting the reveal 1100 around the fenestration frame 704. For instance, as shown the adjustment jacks 116 along the jambs 716, header 712, and sill 714 are operated to translate the fenestration assembly laterally (e.g., to the right) and vertically (e.g., upward) in FIG. 11 to provide a specified reveal 1100, such as a specified spacing, between the fenestration frame 704 and the rough opening boundary surface 706. FIG. 11 includes a plurality of adjustment jacks 116 along each of the header 712, sill 714 and the jambs 716. As previously described herein, in other examples the installation adjustment system 118 includes one or more adjustment jacks along one or more segments of the frame 704. For example, each of the jambs 716 includes a respective adjustment jack 116 and optionally the sill 714 includes an adjustment jack 116.

In the example shown in FIG. 11, the left adjustment jacks 116 of the left jamb 716 are operated (e.g., through rotation or another movement) to translate the adjustment jacks 116 and its engagement feature, such as the engagement foot 308 (or 310) or engagement plate 610 relative to the jamb 716. With the engagement features of the adjustment jacks 116 coupled with the boundary surface 706 the fenestration assembly 700 moves in a converse direction (to the right) and adjusts the reveal 1100 between the left jamb 716 and the proximate surface 706. In a similar manner the adjustment jacks 116 along the sill 714 are operated to address the uneven reveal 1100 proximate the sill 714. The fenestration assembly 700 is accordingly translated within the rough opening 702 to provide a specified reveal 1100 (e.g., a consistent reveal, reveal dimensions or the like) between the assembly 700 and the associated portions of the rough opening 702.

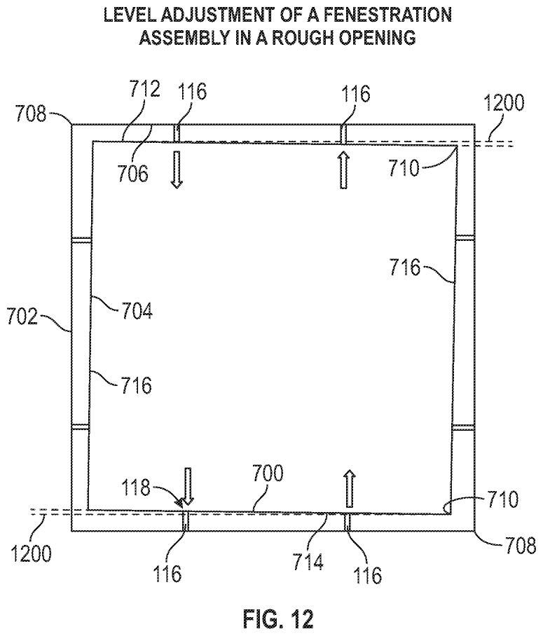

FIG. 12 is another schematic view of the fenestration assembly 700 installed within the rough opening 702. In this example the fenestration assembly is not level relative to the illustrated level line 1200. For instance, one or more portions of the fenestration assembly, such as the header 712 or the assembly 700 itself are not level. The installation adjustment system 118 including the one or more adjustment jacks 116 is operated to adjust the fenestration assembly 700 to achieve a specified installation including moving the assembly 700 into a level orientation (e.g., parallel to level 1200). For instance, as shown the adjustment jacks 116 along one or more of the header 712 or sill 714 move the fenestration assembly in a pivoting or rotating manner within the rough opening 702. FIG. 12 includes a plurality of adjustment jacks 116 along each of the header 712, sill 714 and the jambs 716. As previously described herein, in other examples the installation adjustment system 118 includes one or more adjustment jacks along one or more segments of the frame 704. For example, one or more of the header 712, sill 714 or jambs 716 include one or more adjustment jacks 116, respectively.

In the example shown in FIG. 12, the adjustment jacks 116 of one or more of the sill 714 or the header 712 are operated (e.g., through rotation or another movement) to translate the adjustment jacks 116 and its engagement feature, such as the engagement foot 308 (or 310) or engagement plate 610 (or 650) relative to the proximate portion of the fenestration frame 704. For instance, the left adjustment jack 116 along the sill 714 is moved inwardly or relaxed to pivot the sill 714 (and optionally the remainder of the assembly 700) counterclockwise and parallel to level 1200. Optionally, the right adjustment jack along the sill is moved outwardly (in contrast to inwardly) to push the sill 714 and pivot the sill toward level 1200. In another example, movement of the fenestration assembly, for instance with the one or more adjustment jacks 116 associated with the sill 714 also moves the remainder of the assembly, including the header 712 toward level 1200. Optionally, adjustment jacks 116 along the header 712 are operated to orient heater 712 toward level 1200 in a similar (though converse) manner to the jacks 116 provided along the sill 714.

In still other examples including fewer adjustment jacks along one or more the jambs 716, sill 714 and the header 712 (e.g., one jack along each segment), the jacks 116 are operated in concert to adjust the level of the fenestration assembly. For example, the jacks 116 of the jambs 716 and the sill 714 are operated to provide a coordinated moment to the fenestration assembly 700 that pivots the assembly 700 relative to the rough opening 702 and toward level 1200. In one example, the adjustment jacks 116 of the left and right jambs 716 are operated conversely, one outward (to push) and one inward (to relax) while the jack 116 along the sill 714 is static and serves a pivot point for the fenestration assembly. Accordingly pushing and relaxing of the left and right jacks 116 pivots the fenestration assembly around the jack 116 of the sill 714 and orients each of the sill 714 and the header 712 of the assembly 700 toward level 1200.

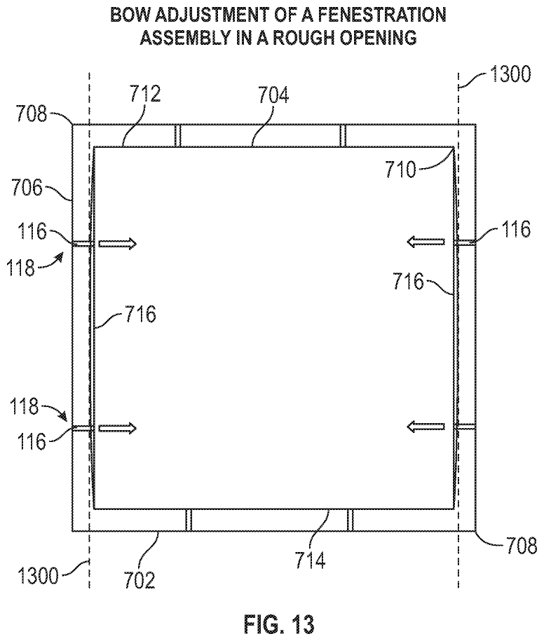

FIG. 13 is a schematic view of the fenestration assembly 700 installed within the rough opening 702 and having one or more of its segments bowed (e.g., jamb-bow, header-bow, sill-bow or the like). In this example the fenestration assembly 700 is shown with jamb-bow relative to vertical 1300. The jambs 716 in this example are bowed, for instance from one or more manufacturing procedures or the like. The installation adjustment system 118 including the one or more adjustment jacks 116 is operated to adjust the fenestration assembly 700 to achieve a specified installation including minimizing bowing (including decreasing or eliminating one or more of jamb-bow, sill-bow or header bow). For instance, as shown the adjustment jacks 116 along the jambs 716 are operated to bias the jambs 716 inwardly and thereby address the bowed configuration shown.

In the example shown in FIG. 13, the jambs 716 include one or more adjustment jacks 116 each. The jacks 116 are operated to extend the jacks toward the proximate portions of the rough opening 706 and provide a counter force to the jambs 716. The engagement feature of the jacks 116, such as the engagement foot 308 (or 310) or engagement plate 610 (or 650) is engaged with the boundary surface 706 of the rough opening 702 and the jacks 116 press the associated jambs 716 inwardly to overcome the jamb-bow.

In other examples, the adjustment jacks 116 described herein are operated to address additional installation characteristics including, but not limited to, off-plumb or off-true installations. As previously described the adjustment jacks 116 are installed to the fenestration frame 704 in a manner generally aligned with horizontal (when included along the jambs 716) or vertical (when included with the sill 714 or header 712). In other examples the adjustment jacks 116 are received within corresponding jack sockets at different orientations. For example, one or more of the jack sockets and associated adjustment jacks 116 are provided at angled orientations. To adjust plumb one or more of the adjustment jacks 116 is provided at an orientation extending, at least partially, into and out of the page of FIG. 13 (or the other similar figures shown herein) or transverse to the plane of the fenestration assembly 700. These adjustment jacks 116, for instance provided along the header 704, facilitate movement of the fenestration frame 704 and the remainder of the assembly 700 in a pivoting manner. The fenestration assembly 700 pivots relative to the sill 714 out of or into the page as the one or more transverse adjustment jacks 116 (along the header 704) correspondingly push or relax the header 704 relative to the rough opening 702.

In another example, transverse adjustment jacks 116 are provided on additional segments of the fenestration frame including one or more of the jambs 716, sill 714 or the header 712. With adjustment jacks 116 extending (at least partially) into and out of the page and transverse to the plane of the fenestration assembly 700 adjustments to true are also conducted. In some examples, the fenestration assembly 700 has a twisted orientation when viewed along the plane of the assembly. For instance, one or both of the jambs 716 are tilted into or out of the page while the opposed jamb 716 is plumb (or aligned with vertical) or at a different angle relative to the first jamb 716. In this example, adjustments to plumb (or level if the sill or header) of the fenestration assembly 700 may not also address true. Instead, by providing one or more adjustment jacks 116 in transverse orientations localized adjustments to the fenestration assembly 700 are conducted with out of true segments to move the segments toward true while other segments are independently adjusted (or held static if already plumb or level). For instance, if a first jamb 716 is plumb and the second jamb 716 is not plumb (e.g., the assembly 700 is not true) the adjustment jacks 116 associated with the second jamb 716 are operated to move the second jamb 716 toward plumb and thereby adjust the fenestration assembly 700 to have a true installation characteristic. In a similar manner adjustments along the sill 714 or header 712 are made with associated transverse adjustment jacks 116.

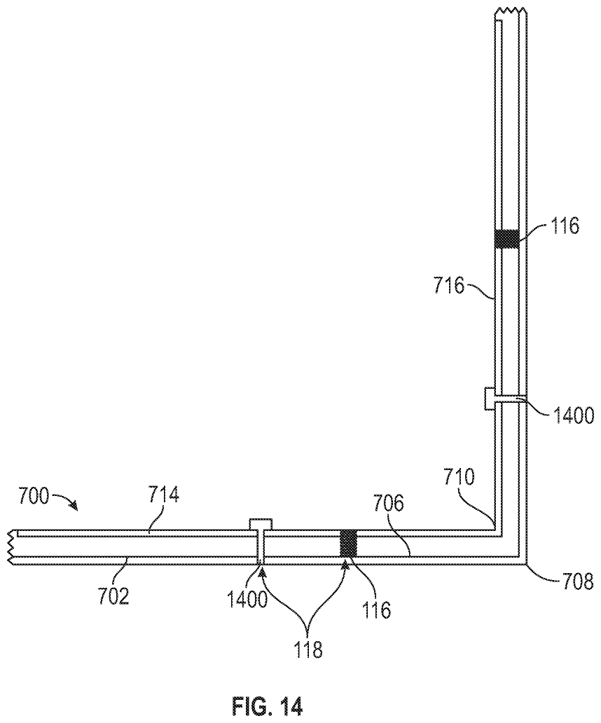

In still other examples, adjustments to installation characteristics including, but not limited to, plumb, level, square, true, reveals or the like are conducted with the adjustment jacks 116 oriented in horizontal and vertical configurations as shown in FIG. 13 with angled surfaces, such as wedges, preinstalled along the rough opening 702. In this example, operation of adjustment jacks 116 associated with one or more of the angled surfaces of the rough opening reconfigures the pushing or relaxation caused by the adjustment jacks 116 to include one or more lateral force components. For instance, as the engagement foot of an adjustment jack 116 is moved inwardly or outwardly the foot translates along the angled surface and accordingly moves the associated portion of the fenestration assembly in a transverse direction corresponding to the angled surface. FIG. 14 is a detailed schematic view of the fenestration assembly 700 having one or more specified installation characteristics, for instance the assembly 700 is square, level, has a specified reveal, and bow of one or more of the segments is overcome. Optionally, the installation adjustment system 118 includes one or more locking fasteners 1400 that anchor the fenestration assembly 700 after adjustment.

In one example, after adjusting the fenestration assembly to the specified characteristics with the adjustment jacks 116 the installer fastens the fenestration assembly 700 to the rough opening 702. Locking fasteners 1400 interconnect one or more of the fenestration segments, such as the sill 714, jambs 716 or the header 712 with the rough opening 702 and hold the assembly 700 in position with the specified installation characteristics. The locking fasteners 1400 include, but are not limited to, screws, bolts, nails, mechanical fittings, shims or the like. In some examples, the locking fasteners 1400 are coupled with the rough opening 702 and the fenestration assembly 700 proximate to the adjustment jacks 116 to minimize moments or torque between the fasteners 1400 and the jacks 116 that may precipitate movement of the jacks 116.

In another example, the fenestration assembly 700 is adjustable after installation, for instance as a building or residence settles. In this example, the locking fastener 1400 is decoupled between the rough opening 702 and the fenestration assembly 700. The adjustment jacks 116 are operated to adjust the orientation of the fenestration assembly again toward the specified installation characteristics. Once the installer is satisfied with the reorientation the locking fasteners 1400 are recoupled between the rough opening 702 and the fenestration frame, such as the sill 714, jambs 716 or the header 712.

Optionally, the locking fastener 1400 is used to initiate movement of the fenestration assembly 700 caused with the adjustment jacks 116. For instance, with adjustments including withdrawal or movement of the adjustment jacks 116 inwardly (toward the fenestration assembly 700) the engagement of the engagement foot is ‘relaxed’ thereby allowing at least the portion of the assembly proximate to the adjustment jack to move in a converse direction otherwise caused with outward movement of the jack 116. In some examples the fenestration assembly 700 does not initially move with the relaxation of the engagement. Instead, the locking fastener 1400 is operated (e.g., tightened, turned or the like) to initiate movement of the fenestration assembly segment. In this example, the inwardly moved adjustment jack 116 operates as a stop or bumper for movement of the assembly 700. As the locking fastener 1400 is tightened and the assembly 700 moves toward the rough opening boundary surface the movement is arrested upon engagement of the relaxed engagement foot with the rough opening 702. Accordingly, the adjustment jack 116 limits further movement of the fenestration assembly beyond the specified adjustment made with the jack 116.

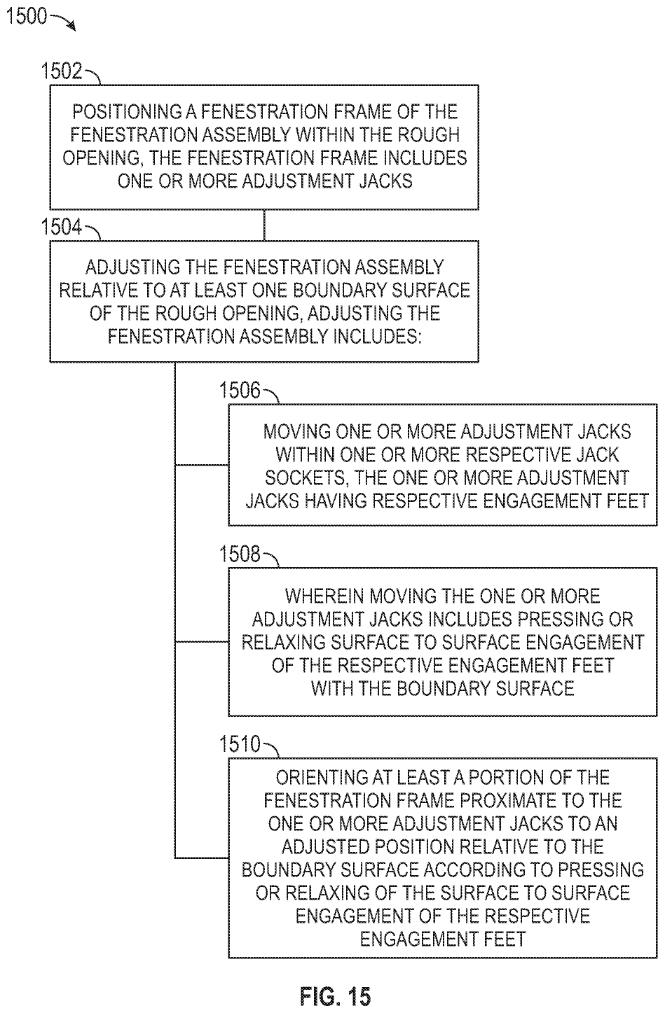

FIG. 15 shows one example of a method 1500 for adjusting a fenestration assembly, such as the fenestration assemblies described herein with one or more of the installation adjustment systems. In describing the method 1500 reference is made to one or more components, features, functions, steps or the like described herein. Where convenient, reference is made to the components, features, functions, steps or the like with reference numerals. Reference numerals provided are exemplary and are not exclusive. For instance, the components, features, functions, steps or the like described in the method 1500 include, but are not limited to, the corresponding numbered elements, other corresponding features described herein, both numbered and unnumbered as well as their equivalents.

At 1502 a fenestration frame 704 (or 102) of the fenestration assembly 700 (or 100) is positioned within a rough opening, such as the rough opening 702 (FIG. 7). The fenestration frame 704 includes one or more adjustment jacks 116. As described herein, the adjustment jacks 116 include in example a contoured jack profile complementary to a corresponding contoured socket profile. Relative movement between the profiles moves the jack 116 relative to the associated socket. The adjustment jacks 116 further include an engagement feature that provides surface to surface contact between the jack and a boundary surface of a rough opening (e.g., without penetration of the material of the rough opening). The engagement feature, such as a foot, plate or the like, pushes and relaxes its engagement to adjust the fenestration assembly 700.

At 1504 the method 1500 includes adjusting the fenestration assembly 700 relative to at least one boundary surface of the rough opening 702. Adjusting the fenestration assembly includes moving one or more adjustment jacks 116 within one or more respective jack sockets (e.g., socket 200 shown in FIG. 2) at 1506. At 1508 moving the one or more adjustment jacks includes pressing or relaxing surface to surface engagement of the respective engagement feet with the boundary surface (e.g., surface 706 in FIG. 7). At 1510 the method 1500 includes orienting at least a portion of the fenestration frame 704 proximate to the one or more adjustment jacks 116 to an adjusted position relative to the boundary surface 706 according to pressing or relaxing of the surface to surface engagement of the respective engagement feet (e.g., 308, 310 or 612, 654).

Options for the method 1500 follow. In one example, moving the one or more adjustment jacks 116 includes driving a contoured jack profile 300 of the one or more adjustment jacks 116 over a contoured socket profile 420 of the one or more jack sockets 200. In another example, the profiles 300, 420 are threaded or other graduated profiles configured to graduate translational movement of the adjustment jacks 116 with rotational movement. Additionally, the profiles 300, 420 are configured to retain adjusted relative positions to corresponding maintain the engagement features, such as the feet, plates or like, in an as-adjusted location and thereby retain the fenestration assembly in an adjusted orientation including one or more specified installation characteristics (e.g., including, but not limited to, square, level, true, plumb, reveal or bow).

In another example, the method 1500 includes anchoring the fenestration frame 704 in the adjusted position with a locking fastener 1400 of the installation adjustment system. Optionally, the locking fastener 1400 is distinct from the adjustment jack 116. The method optionally includes decoupling the locking fastener 1400 from the boundary surface of the rough opening 702 and moving the one or more adjustment jacks 116. Movement of the adjustment jacks 116 orients at least the portion of the fenestration frame 704 proximate to the one or more adjustment jacks to an adjusted position relative to the boundary surface 706 according to pressing or relaxing of the surface to surface engagement of the respective engagement feet. Optionally, the method 1500 includes positioning another example of a locking fastener between the fenestration frame 704 and the boundary surface 706, such as one or more shims.

In other examples, the method 1500 includes coupling the one or more jack sockets, for instance as jack inserts 402, with the fenestration frame 102. The jack inserts 402 provide the contoured socket profile Optionally, the jack sockets 200 are integral to or components of the fenestration frame 102 including the material of the fenestration frame 102, such as metal, polymer, composites or the like having the contoured socket profile.

### Various Notes & Examples

Aspect 1 can include subject matter such as a fenestration assembly comprising: a fenestration frame including an interior perimeter portion and an exterior perimeter portion, wherein the exterior perimeter portion of the fenestration frame is configured for positioning in a rough opening of a building; at least one panel coupled with the fenestration frame; one or more jack sockets included in the fenestration frame and the one or more jack sockets each include a contoured socket profile; one or more adjustment jacks configured to adjust the position of the fenestration frame with respect to the rough opening, wherein each of the one or more adjustment jacks include: a contoured jack profile complementary to the contoured socket profile, the contoured jack profile movably coupled along the contoured socket profile; and an engagement foot configured for surface to surface engagement with a boundary surface of the rough opening; wherein operation of the adjustment jack is configured to drive the contoured jack profile over the contoured socket profile and translate the fenestration frame relative to the engagement foot in surface to surface engagement with the boundary surface; and a locking fastener configured to fix the position of the fenestration frame with respect to the rough opening.

Aspect 2 can include, or can optionally be combined with the subject matter of Aspect 1, to optionally include wherein the adjustment jack is installed through the exterior perimeter portion of the fenestration frame into the jack socket.

Aspect 3 can include, or can optionally be combined with the subject matter of one or any combination of Aspects 1 or 2 to optionally include wherein the fenestration frame includes one or more jack access ports, and the one or more jack access ports are located along the interior perimeter portion of the fenestration frame, and wherein the jack access ports reveal an operation feature of the one or more adjustment jacks.

Aspect 4 can include, or can optionally be combined with the subject matter of one or any combination of Aspects 1-3 to optionally include wherein the jack socket includes a proximate portion of the fenestration frame extending around the adjustment jack.

Aspect 5 can include, or can optionally be combined with the subject matter of one or any combination of Aspects 1-4 to optionally include wherein: the fenestration frame includes one or more jack recesses extending between the exterior and interior perimeter portions of the fenestration frame; and the one or more jack sockets include one or more jack inserts within the one or more jack recesses, the jack inserts having the contoured socket profile.

Aspect 6 can include, or can optionally be combined with the subject matter of Aspects 1-5 to optionally include wherein the adjustment jack includes a first end and a second end, and each of the first and second ends include an operation feature configured to install or operate the adjustment jack.

Aspect 7 can include, or can optionally be combined with the subject matter of Aspects 1-6 to optionally include wherein the operation features of the first and second ends include driver sockets.

Aspect 8 can include, or can optionally be combined with the subject matter of Aspects 1-7 to optionally include wherein the engagement foot includes a plate surface proximate one of first or second ends of the adjustment jack.

Aspect 9 can include, or can optionally be combined with the subject matter of Aspects 1-8 to optionally include wherein the plate surface is oriented parallel to the boundary surface of the rough opening.

Aspect 10 can include, or can optionally be combined with the subject matter of Aspects 1-9 to optionally include wherein the panel is moveable between an open position and a closed position.

Aspect 11 can include, or can optionally be combined with the subject matter of Aspects 1-10 to optionally include the rough opening and the boundary surface of the rough opening.

Aspect 12 can include, or can optionally be combined with the subject matter of Aspects 1-11 to optionally include a fenestration installation adjustment system, comprising: one or more jack sockets configured to couple with a fenestration frame of a fenestration assembly, wherein the one or more jack sockets include a contoured socket profile; one or more adjustment jacks, each of the one or more adjustment jacks is received in one of the one or more jack sockets, wherein each adjustment jack includes: a contoured jack profile complementary to the contoured socket profile, the adjustment jack and the contoured jack profile movable relative to the respective jack socket along the contoured socket profile; an engagement foot configured for surface to surface engagement with a rough opening boundary surface; and wherein movement of the adjustment jack relative to the jack socket is configured to move the fenestration frame according to the relative movement.

Aspect 13 can include, or can optionally be combined with the subject matter of Aspects 1-12 to optionally include wherein the one or more jack sockets are configured for reception in corresponding one or more jack recesses extending between exterior and interior portions of the fenestration frame.

Aspect 14 can include, or can optionally be combined with the subject matter of Aspects 1-13 to optionally include wherein the jack socket includes jack insert having: a first flange positioned at a first end of the jack insert; a second flange positioned at a second end of the jack insert; and wherein the jack insert is configured to receive a portion of the fenestration frame between the first flange and the second flange and anchor the jack insert with the fenestration frame.

Aspect 15 can include, or can optionally be combined with the subject matter of Aspects 1-14 to optionally include wherein the jack insert includes one or more deflectable fingers, and the one or more deflectable fingers are suspended between one or more slots in the jack socket.

Aspect 16 can include, or can optionally be combined with the subject matter of Aspects 1-15 to optionally include wherein the one or more jack sockets each include one or more interference ridges extending from the respective jack sockets, and the one or more interference ridges are configured to engage with the fenestration frame to provide an interference fit between the jack socket and the fenestration frame.

Aspect 17 can include, or can optionally be combined with the subject matter of Aspects 1-16 to optionally include a method for installing a fenestration assembly in a rough opening of a building, comprising: positioning a fenestration frame of the fenestration assembly within the rough opening, the fenestration frame includes one or more adjustment jacks; adjusting the fenestration assembly relative to at least one boundary surface of the rough opening, adjusting the fenestration assembly includes: moving one or more adjustment jacks within one or more respective jack sockets, the one or more adjustment jacks having respective engagement feet; wherein moving the one or more adjustment jacks includes pressing or relaxing surface to surface engagement of the respective engagement feet with the boundary surface; and orienting at least a portion of the fenestration frame proximate to the one or more adjustment jacks to an adjusted position relative to the boundary surface according to pressing or relaxing of the surface to surface engagement of the respective engagement feet.

Aspect 18 can include, or can optionally be combined with the subject matter of Aspects 1-17 to optionally include wherein moving the one or more adjustment jacks includes driving a contoured jack profile of the one or more adjustment jacks over a contoured socket profile of the one or more jack sockets.

Aspect 19 can include, or can optionally be combined with the subject matter of Aspects 1-18 to optionally include engaging the engagement feet of the one or more adjustment jacks with the boundary surface of the rough opening.

Aspect 20 can include, or can optionally be combined with the subject matter of Aspects 1-19 to optionally include anchoring the fenestration frame in the adjusted position with a locking fastener between the fenestration frame and the boundary surface.

Aspect 21 can include, or can optionally be combined with the subject matter of Aspects 1-20 to optionally include decoupling the locking fastener from the boundary surface of the rough opening; moving the one or more adjustment jacks; orienting at least the portion of the fenestration frame proximate to the one or more adjustment jacks to the adjusted position relative to the boundary surface according to pressing or relaxing of the surface to surface engagement of the respective engagement feet.

Aspect 22 can include, or can optionally be combined with the subject matter of Aspects 1-21 to optionally include positioning one or more shims between the fenestration frame and the boundary surface of the rough opening.

Aspect 23 can include, or can optionally be combined with the subject matter of Aspects 1-22 to optionally include coupling the one or more jack sockets with the fenestration frame.

Aspect 24 can include, or can optionally be combined with the subject matter of Aspects 1-23 to optionally include coupling the one or more adjustment jacks with the one or more jack sockets.

Each of these non-limiting aspects can stand on its own, or can be combined in various permutations or combinations with one or more of the other aspects.

The above description includes references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

Geometric terms, such as “parallel”, “perpendicular”, “round”, or “square”, are not intended to require absolute mathematical precision, unless the context indicates otherwise. Instead, such geometric terms allow for variations due to manufacturing or equivalent functions. For example, if an element is described as “round” or “generally round,” a component that is not precisely circular (e.g., one that is slightly oblong or is a many-sided polygon) is still encompassed by this description.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to comply with 37 C.F.R. § 1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

1. A fenestration assembly comprising:
a fenestration frame including an interior perimeter portion and an exterior perimeter portion, wherein the exterior perimeter portion of the fenestration frame is configured for positioning in a rough opening of a building;
at least one panel coupled with the fenestration frame;
one or more jack sockets included in the fenestration frame and the one or more jack sockets each include a contoured socket profile;
one or more adjustment jacks configured to adjust the position of the fenestration frame with respect to the rough opening, wherein each of the one or more adjustment jacks include:
a contoured jack profile complementary to the contoured socket profile, the contoured jack profile movably coupled along the contoured socket profile; and
an engagement foot configured for surface to surface engagement with a boundary surface of the rough opening;
wherein operation of the adjustment jack is configured to drive the contoured jack profile over the contoured socket profile and translate the fenestration frame relative to the engagement foot in surface to surface engagement with the boundary surface; and
a locking fastener configured to fix the position of the fenestration frame with respect to the rough opening.

2. The fenestration assembly of claim 1, wherein the adjustment jack is installed through the exterior perimeter portion of the fenestration frame into the jack socket.

3. The fenestration assembly of claim 1, wherein the fenestration frame includes one or more jack access ports, and the one or more jack access ports are located along the interior perimeter portion of the fenestration frame, and wherein the jack access ports reveal an operation feature of the one or more adjustment jacks.

4. The fenestration assembly of claim 1, wherein the jack socket includes a proximate portion of the fenestration frame extending around the adjustment jack.

5. The fenestration assembly of claim 1, wherein:
the fenestration frame includes one or more jack recesses extending between the exterior and interior perimeter portions of the fenestration frame; and
the one or more jack sockets include one or more jack inserts within the one or more jack recesses, the jack inserts having the contoured socket profile.

6. The fenestration assembly of claim 1, wherein the adjustment jack includes a first end and a second end, and each of the first and second ends include an operation feature configured to install or operate the adjustment jack.

7. The fenestration assembly of claim 6, wherein the operation features of the first and second ends include driver sockets.

8. The fenestration assembly of claim 1, wherein the engagement foot includes a plate surface proximate one of first or second ends of the adjustment jack.

9. The fenestration assembly of claim 8, wherein the plate surface is oriented parallel to the boundary surface of the rough opening.

10. The fenestration assembly of claim 1, wherein the panel is moveable between an open position and a closed position.

11. The fenestration assembly of claim 1 comprising the rough opening and the boundary surface of the rough opening.

12. A fenestration installation adjustment system comprising:
one or more jack sockets configured to couple with a fenestration frame of a fenestration assembly, wherein the one or more jack sockets include a contoured socket profile;
one or more adjustment jacks, each of the one or more adjustment jacks is received in one of the one or more jack sockets, wherein each adjustment jack includes:
a contoured jack profile complementary to the contoured socket profile, the adjustment jack and the contoured jack profile movable relative to the respective jack socket along the contoured socket profile;
an engagement foot configured for surface to surface engagement with a rough opening boundary surface; and
wherein movement of the adjustment jack relative to the jack socket is configured to move the fenestration frame according to the relative movement.

13. The fenestration installation adjustment system of claim 12, wherein the one or more jack sockets are configured for reception in corresponding one or more jack recesses extending between exterior and interior portions of the fenestration frame.

14. The fenestration installation adjustment system of claim 12, wherein the jack socket includes jack insert having:
a first flange positioned at a first end of the jack insert;
a second flange positioned at a second end of the jack insert; and
wherein the jack insert is configured to receive a portion of the fenestration frame between the first flange and the second flange and anchor the jack insert with the fenestration frame.

15. The fenestration installation adjustment system of claim 13, wherein the jack insert includes one or more deflectable fingers, and the one or more deflectable fingers are suspended between one or more slots in the jack socket.

16. The fenestration installation adjustment system of claim 12, wherein the one or more jack sockets each include one or more interference ridges extending from the respective jack sockets, and the one or more interference ridges are configured to engage with the fenestration frame to provide an interference fit between the jack socket and the fenestration frame.

17. A method for installing a fenestration assembly in a rough opening of a building comprising:
positioning a fenestration frame of the fenestration assembly within the rough opening, the fenestration frame includes one or more adjustment jacks;
adjusting the fenestration assembly relative to at least one boundary surface of the rough opening, adjusting the fenestration assembly includes:
moving one or more adjustment jacks within one or more respective jack sockets, the one or more adjustment jacks having respective engagement feet;
wherein moving the one or more adjustment jacks includes pressing or relaxing surface to surface engagement of the respective engagement feet with the boundary surface; and
orienting at least a portion of the fenestration frame proximate to the one or more adjustment jacks to an adjusted position relative to the boundary surface according to pressing or relaxing of the surface to surface engagement of the respective engagement feet.

18. The method of claim 17, wherein moving the one or more adjustment jacks includes driving a contoured jack profile of the one or more adjustment jacks over a contoured socket profile of the one or more jack sockets.

19. The method of claim 17 comprising engaging the engagement feet of the one or more adjustment jacks with the boundary surface of the rough opening.

20. The method of claim 17 comprising anchoring the fenestration frame in the adjusted position with a locking fastener between the fenestration frame and the boundary surface.

21. The method of claim 20 comprising:
decoupling the locking fastener from the boundary surface of the rough opening;
moving the one or more adjustment jacks;
orienting at least the portion of the fenestration frame proximate to the one or more adjustment jacks to the adjusted position relative to the boundary surface according to pressing or relaxing of the surface to surface engagement of the respective engagement feet.

22. The method of claim 17 comprising positioning one or more shims between the fenestration frame and the boundary surface of the rough opening.

23. The method of claim 17 comprising coupling the one or more jack sockets with the fenestration frame.

24. The method of claim 17 comprising coupling the one or more adjustment jacks with the one or more jack sockets.
